(19) United States
(12) Patent Application Publication
(10) Pub. No.: US 2007/0139688 A1
(43) Pub. Date: Jun. 21, 2007

(54) Hard-copy document having embedded lifecycle and history information

(76) Inventor: Gavan L. Tredoux, Penfield, NY (US)

Correspondence Address: Clifford P. Kelly;Alix, Yale & Ristas, LLP, 750 Main Street, Hartford, CT, 06103-2721, US

(21) Appl. No.: 11/312,817

(22) Filed: Dec. 20, 2005

(51) Int. Cl. G06K 15/00

(52) U.S. Cl. 358/1.14; 358/474

(57) ABSTRACT

A hard-copy authentication document has at least one digital channel franked on the document. The digital channel provides a physical manifestation of a digital representation of a state of the document. In a method of authentication and non-repudiation of hard-copy documents, at least one digital channel is affixed to the document.

### BACKGROUND

This disclosure relates generally to the authentication and non-repudiation of hard-copy communications. More particularly, the present embodiment relates to an apparatus and method for embedding lifecycle information and non-repudiable sequence traces within hard-copy documents.

Many printed documents have an intended lifecycle prescribing a set of transformation processes the document may undergo, where the precise order and history of such transformations is important. For example, documents which require review and approval before they are deemed valid require that other elements of the document be completed before approval may be issued. This requirement is violated when a document is approved in advance and then filled in later. Existing solutions to this type of problem include clerical, administrative, legal controls and sanctions for non-conformance. These procedures are inexact, are liable to error, and risk repudiation of the document, with the subsequent dispute and litigation.

U.S. Pat. No. 5,157,726, issued Oct. 20, 1992, describes a method for digitally signing the state of a printed document and subsequently verifying it, with the signature represented visibly on the document. U.S. Patent Application 2004/0117627 describes a related method for including document state information within a printed document. The methods described in these documents provide solutions to the shortcomings described in therein. However these methods are not sufficient to prove that a printed document has undergone the required transformation process in the required sequence.

### SUMMARY

There is provided a hard-copy authentication document having at least one digital channel franked on the document. The digital channel provides a physical manifestation of a digital representation of a state of the document.

The document has a lifecycle comprising multiple states of the document, and the document comprises multiple digital channels with each of the digital channels being associated with one of the states of the document. The document may comprise a digital channel for each of the states of the document.

A set of business rules are applied to the document over the lifecycle with the business rules and the lifecycle defining a lifecycle specification. The document may further comprise a physical manifestation of a digital representation of the lifecycle specification. The document may further comprise a physical manifestation of a digital signature.

In a method of authentication and non-repudiation of hard-copy documents, at least one digital channel is affixed to a hard-copy document. The digital channel provides a physical manifestation of a digital representation of a state of the document.

The method also comprises scanning the document with a scanner or a multi-function printer/copier/scanner device and generating a digital representation of the document's state from the scanned image of the document. Alternatively, specified elements or components of the scanned image of the document may be selected and a digital representation of the document's state generated from the selected elements or components.

The document has a lifecycle comprising a plurality of states of the document. The method may further comprise affixing multiple digital channels to the document, with each of the digital channels providing a physical manifestation of a digital representation of a one of the states of the document.

In this embodiment, the method further comprises scanning the document in a first state with a scanner or a multi-function printer/copier/scanner device, generating a first digital representation of the document's state from the scanned image of the document, and affixing a first digital channel to the document. Then the document is scanned in a subsequent state, a subsequent digital representation of the document's state is generated from the scanned image of the document, and a subsequent digital channel is affixed to the document. The document may be scanned in each subsequent state, with a digital channel of each subsequent state being affixed to the document.

A set of business rules are applied to the document over the lifecycle, with the business rules and the lifecycle defining a lifecycle specification. The method may further comprise affixing a physical manifestation of a digital representation of the lifecycle specification on the document.

In this embodiment, the method may further comprise scanning the document and digital channel, interpreting the scanned digital channel to obtain lifecycle information, comparing the lifecycle information to the lifecycle specification, and determining if the document is compliant with the lifecycle specification.

In this embodiment the method may alternatively further comprise scanning the scanning the document, the digital channel and the physical manifestation of the digital representation of the lifecycle specification, interpreting the digital representation of the lifecycle specification to obtain the lifecycle specification, comparing the lifecycle specification to an instruction of an operator, and either permitting the instruction if the instruction is allowed by the lifecycle specification, or denying the instruction if the instruction is not allowed by the lifecycle specification. If the instruction was denied, a message may be transmitted to an operator. If the operator initiates a subsequent instruction allowed by the lifecycle specification, in response to the message, the instruction is then permitted.

In this embodiment the method may further alternatively comprise scanning the scanning the document, the digital channel and the physical manifestation of the digital representation of the lifecycle specification, interpreting the scanned digital channel to obtain lifecycle information, interpreting the digital representation of the lifecycle specification to obtain the lifecycle specification, comparing the lifecycle specification to the lifecycle information, and initiating an action required by the lifecycle specification if the action is not located in the lifecycle information.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic diagram of apparatus for creating a physical manifestation of the digital signature/digital certificate;

FIG. 2 is flow diagram of a method for embedding lifecycle information and non-repudiable sequence traces within hard-copy documents;

FIG. 3 is a flow diagram of a method for verifying that a hard-copy document conforms with an associated lifecycle; and

FIG. 4 is a flow diagram of a method for enforcing the lifecycle of a hard-copy document.

### DETAILED DESCRIPTION

Documents are often treated as static, complete, entities. While the consistency of information they contain may be checked, especially in the case of forms, less precise attention is given to the way in which they acquire that information. Yet documents are not necessarily static and may evolve over time. The order in which information is added to them may be important in its own right.

The series of changes undergone by a document is referred to herein as the document's lifecycle. It is useful to be able to apply business rules to a document over its lifecycle, and different business rules may apply at different stages of the lifecycle. If a lifecycle is combined with business rules in this way, a document behavior specification is formed. Such specifications can be used to characterize and constrain the behavior and evolution of a document over time. It should be appreciated that lifecycle specifications can impose stringent requirements on the sequence of approvals, and may make state transitions dependent on assertions about document states. For example, the lifecycle may require that, if an amount field in the document exceeds a certain threshold, signatures from those with greater authority have to be obtained. Moreover, the lifecycle specification is just that—a specification—and should not be confused with an executable workflow program. The document lifecycle is passive and a description of what can happen to a document, not a recipe or mechanism for making things happen to it.

Documents generally display a varying degree of compliance with their associated business rule specification. A class of these documents, high-integrity documents (HIDs) fully comply with their associated business rule specification. By satisfying the business rules, high integrity documents raise the probability that they achieve their intended purpose. The usefulness of this depends on the expressive power of the behavior specification with respect to the wide variety of behaviors involving documents and the contexts they may appear in.

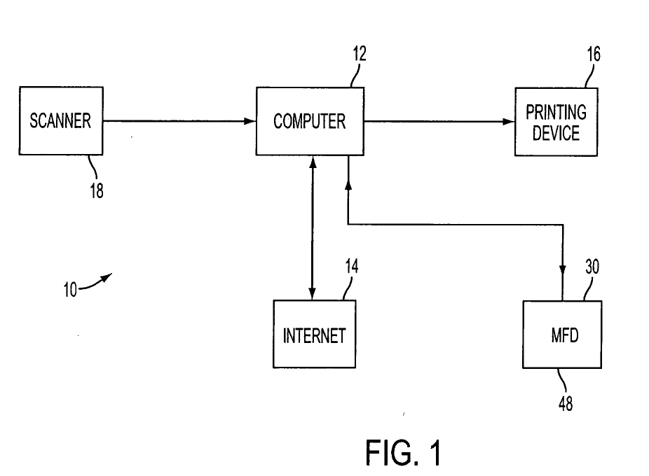

With reference to the drawings wherein like numerals represent like parts throughout the several figures, and more particularly to FIG. 1, there is shown an apparatus 10 for embedding lifecycle information within a hard-copy document, and for verifying that such a document conforms with an associated lifecycle. The apparatus 10 comprises a computer system 12, including a keyboard, a display and a mouse (none of which are shown), and is connected to the Internet 14. In addition, the computer system 12 includes a printing device 16 and a scanning device 18, as explained in greater detail below. It should be appreciated that the printing device 16 and the scanning device 18 may be parts of a multifunction device 30, such as a digital copier. It should also be appreciated that a digital camera may be used in place of the scanning device 18.

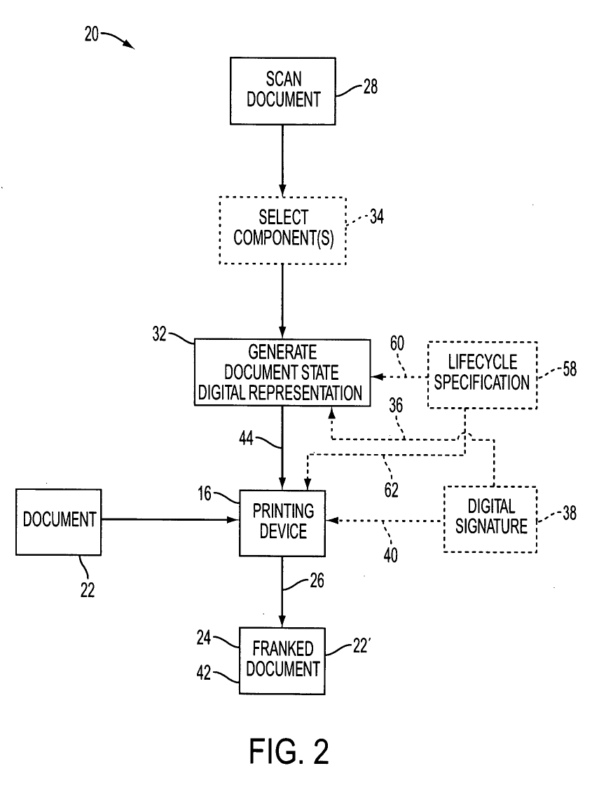

The subject method 20 for franking a hard-copy document 22 provides a history of the state transformations that the document has undergone (FIG. 2). More specifically, the state of the document 22 at each stage of the document lifecycle is franked 26 onto the document 22, thereby providing a history of the state transformations. As defined herein, the “state” of a document is any unambiguous representation of the document's contents at a point in time. For printed documents 22, it is “what the document looks like” at that time. The document 22 can carry, encoded within a digital channel 24, information about which of its elements make up its “state”. The term “franking” is hereby defined as any manner of affixing a machine readable format to a document, such as through printing. As defined herein, a “digital channel” is a machine readable format bound to the hard-copy document 22 having a capacity sufficient to display the complete data content of a digital representation of the state of the document 44 meeting the criteria of applicable industry standards, such as two-dimensional barcodes, or DataGlyphs®. This history of transformations can be inspected to determine if a document complies with its associated business rule specification, or more specifically, whether the document has been used in a way that satisfies the lifecycle requirements for the document. The inspection may be conducted by the human eye, or it may be automated, depending on the extent of the lifecycle guarantees desired. Each time a document is altered, it is franked 26 to record its progress through its lifecycle.

Non-repudiable sequence traces 24 may be franked 26 onto a hard-copy, printed document 22 by first, scanning 28 the document 22 with a scanner 18 or a multi-function printer/copier/scanner device (MFD) 30. A digital representation of the document's state 44 is generated 32 from the scanned image of the document 22. If it is necessary to limit the physical size of the representation 24 that must be embedded on the document 22, the representation of the document's state 44 may be generated from specified elements or components of the document 22. In this case, such specified elements or components must be selected 34 from the digital file created by scanning 28 the document 22.

The digital representation of the state of the document 44 may be “signed”, by affixing 36 a physical representation of a digital signature 38 to the digital representation of the state of the document. As defined herein, a “digital signature” is any digital information that may be used to indicate the identity of the person who signed the document and that is very difficult for another person to produce without authorization. The term “physical manifestation of the digital signature” is hereby defined as a machine readable format bound to the document, such as through printing, having a capacity sufficient to display the complete data content of a digital signature meeting the criteria of applicable industry standards.

Alternatively, the digital signature 38 may be transmitted 40 separately to the printing device 16. Such digital signature 38 may be generated by any digital signature scheme, for example the method for creating a physical manifestation of a digital signature disclosed in co-pending U.S. patent application Ser. No. 11/131,641 filed May 18, 2005 and assigned to Xerox Corporation. The digital channel 24, and the physical manifestation of a digital signature 42 if appropriate, are affixed to the hard-copy document 22 by a printing device 16, thereby franking 26 the hard-copy document 22. If a multi-function printer/copier/scanner device 30 has been used to scan 28 the document 22, the digital channel 24 and physical manifestation of the digital signature 44 may be easily printed by merely inserting the document 22 into the single-sheet bypass paper tray commonly found on such devices 30. Alternatively, specialized franking hardware can be constructed that combines document scanning, processing and printing capability in a single-pass.

As discussed above, repeatedly embedding the digital representation of the state of the document 44 in the document 22 records a non-repudiable history of document states and transformations on the document itself. In the case of documents 22 which require multiple stages of review and approval, each franked state establishes exactly what was approved and by whom. Most importantly, the recorded sequence of approvals establishes unambiguously whether the correct order of review/approval steps was followed throughout the lifecycle of the document.

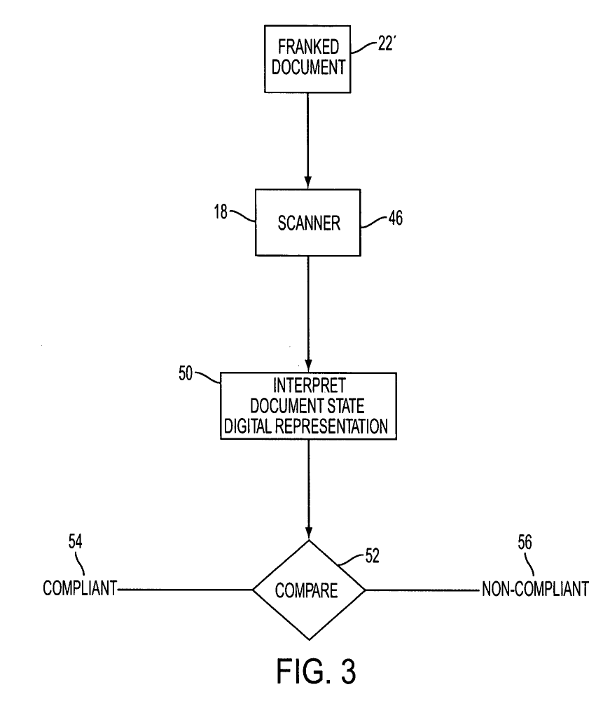

With reference to FIG. 3, the subject apparatus 10 may be easily used to determine to what degree a franked hard-copy document 22′ conforms with an associated lifecycle. The franked document 22′ is scanned by a scanner/copier/multi function device 30, the digital channel 24 is interpreted 50 by a processor 48 associated with the scanner/copier/multi function device 30, or by the computer 12. The lifecycle information provided in this manner may be compared 52 to the lifecycle specification requirements to determine if the franked document 22 is compliant 54 with the requirements or non-compliant 56.

A digital representation of the lifecycle specification 58 may also be embedded in the document 22 itself. As shown in FIG. 2, the lifecycle specification 58 may be added 60 to the digital representation of the state of the document. Alternatively, the lifecycle specification 58 may be transmitted 62 separately to the printing device 16 and embedded in the document 22 as is known in the art. Because the franked history and lifecycle specification are carried with the document itself, the document 22′ may cross organizational boundaries and still provide a checkable guarantee of integrity. Verification may proceed on demand, perhaps only when the veracity of a document 22′ is challenged, depending on organizational policies.

If both a digital representation of the lifecycle specification 58 and the digital channel 24 are embedded in the document 22′, it is possible to automatically determine to what degree a franked hard-copy document 22′ conforms with an associated lifecycle 58. In the example shown in FIG. 3, the processor 48 of the scanner/copier/multi function device 30 or the computer 12 will compare 52 the digital representation of the lifecycle specification 58 to the digital representations of the state of the document 44 to determine whether each such snapshot of the life of the document 22′ complies with the specification requirements.

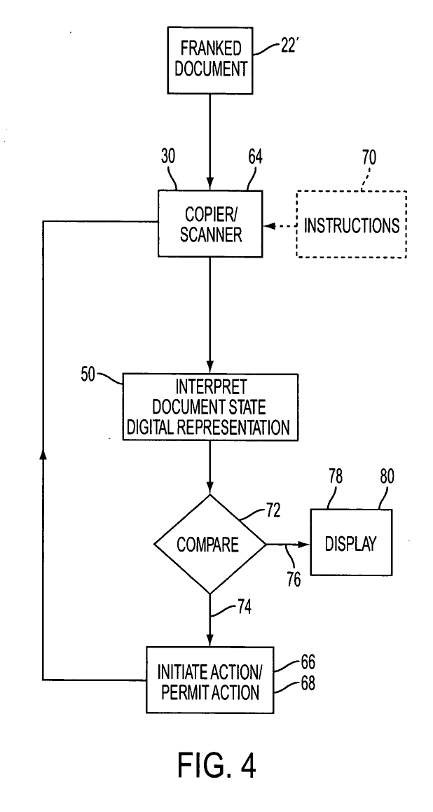

In addition, when a document is franked with both a digital representation of the lifecycle specification 58 and the digital channel 24, certain of the requirements set forth in the lifecycle specification 58 may be automatically enforced (FIG. 4). When such a document 22′ is scanned 64 by a scanner/copier/multi function device 30, the lifecycle specification requirements and the digital representation of the state of the document 44 may be interpreted by the processor 48 of the scanner/copier/multi function device 30 or the computer 12. The requirements set forth in the lifecycle specification 58 may then by utilized by the processor 48 or computer 12 to either initiate 66 an action or to allow 68 an action to take place.

For example, if the operator instructed 70 the device 30 to produce copies of the document 22′, the processor 48 or computer 12 would compare 72 this instruction 70 to the actions permitted by the lifecycle specification 58 to determine whether it was permissible to produce the copies. If the lifecycle specification 58 allowed 74 uncontrolled copying of the document 22′, the processor or computer would permit 68 the device 30 to produce the copies. If the lifecycle specification 58 did not allow 76 uncontrolled copying of the document 22′, the processor 48 or computer 12 would transmit a message 78 to a display 80 indicating that copying of the document 22′ was not permitted. If the lifecycle specification 58 allowed controlled copying of the document 22′, the message 78 could require that an authorization code be entered before printing would be permitted. Upon entry 70 of such a code, the processor 48 or computer 12 would permit 68 the device 30 to produce the copies.

The processor 48 or computer 12 may initiate an action required by the lifecycle specification requirements. For example, the comparison 72 of the lifecycle specification requirements to the digital representation of the state of the document 44 may indicate that a required review of the document 22′ has not taken place. In one alternative, the processor 48 or computer 12 initiates 66 production of a copy of the document 22′ addressed to the individual/organizational position indicated in the lifecycle specification 58. In another alternative, the processor 48 or computer 12 initiates 66 transmission of an electronic copy of the document 22′ to the individual/organizational position indicated in the lifecycle specification 58.

It should be appreciated that the subject method may also be applied to digital documents, where a digital document is any named/identified collection of data or information. A digital authentication document comprises a digital document having at least one digital channel providing a digital representation of a state of the document. The digital authentication document may include a digital channel associated with each state of the document over the lifecycle of the document. The digital authentication document may also include a digital representation of the lifecycle specification of the document.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A hard-copy authentication document comprises at least one digital channel franked on the document, the at least one digital channel providing a physical manifestation of a digital representation of a state of the document.

2. The hard-copy authentication document of claim 1 wherein the document has a lifecycle comprising a plurality of states of the document, the document comprising a plurality of digital channels, each of the digital channels providing a physical manifestation of a digital representation of a one of the states of the document.

3. The hard-copy authentication document of claim 2 wherein the document comprises a digital channel providing a physical manifestation of a digital representation of each of the states of the document.

4. The hard-copy authentication document of claim 1 further comprising a physical manifestation of a digital signature.

5. The hard-copy authentication document of claim 2 wherein a set of business rules are applied to the document over the lifecycle, the business rules and the lifecycle defining a lifecycle specification, the document further comprising a physical manifestation of a digital representation of the lifecycle specification franked on the document.

6. A method of authentication and non-repudiation of hard-copy documents comprising affixing at least one digital channel to a hard-copy document, the at least one digital channel providing a physical manifestation of a digital representation of a state of the document.

7. The method of claim 6 further comprising:
scanning the document with a scanner or a multi-function printer/copier/scanner device; and
generating a digital representation of the document's state from the scanned image of the document.

8. The method of claim 6 further comprising:
scanning the document with a scanner or a multi-function printer/copier/scanner device;
selecting specified elements or components of the scanned image of the document;
generating a digital representation of the document's state from the selected elements or components.

9. The method of claim 6, wherein the document has a lifecycle comprising a plurality of states of the document, the method further comprising affixing a plurality of digital channels to the document, each of the digital channels providing a physical manifestation of a digital representation of a one of the states of the document.

10. The method of claim 9 further comprising:
scanning the document in a first state with a scanner or a multi-function printer/copier/scanner device;
generating a first digital representation of the document's state from the scanned image of the document;
affixing a first digital channel to the document, the first digital channel providing a physical manifestation of the first digital representation of the document's state;
scanning the document in a subsequent state with a scanner or a multi-function printer/copier/scanner device;
generating a subsequent digital representation of the document's state from the scanned image of the document;
affixing a subsequent digital channel to the document, the subsequent digital channel providing a physical manifestation of the subsequent digital representation of the document's state.

11. The method of claim 9 further comprising:
scanning the document in a first state with a scanner or a multi-function printer/copier/scanner device;
generating a first digital representation of the document's state from the scanned image of the document;
affixing a first digital channel to the document, the first digital channel providing a physical manifestation of the first digital representation of the document's state;
scanning the document in each subsequent state with a scanner or a multi-function printer/copier/scanner device;
generating a subsequent digital representation of the document's state from the scanned image of the document;
affixing a subsequent digital channel to the document, the subsequent digital channel providing a physical manifestation of the subsequent digital representation of the document's state.

12. The method of claim 9 wherein a set of business rules are applied to the document over the lifecycle, the business rules and the lifecycle defining a lifecycle specification, the method further comprising affixing a physical manifestation of a digital representation of the lifecycle specification on the document.

13. The method of claim 6 further comprising affixing a physical manifestation of a digital signature to the document.

14. The method of claim 6 wherein the document has a lifecycle comprising a plurality of states of the document and a set of business rules are applied to the document over the lifecycle, the business rules and the lifecycle defining a lifecycle specification, the method further comprising:
scanning the document and digital channel;
interpreting the scanned digital channel to obtain lifecycle information;
comparing the lifecycle information to the lifecycle specification; and
determining if the document is compliant with the lifecycle specification.

15. The method of claim 12 further comprising:
scanning the document, the digital channel and the physical manifestation of the digital representation of the lifecycle specification;
interpreting the scanned digital channel to obtain lifecycle information;
interpreting the digital representation of the lifecycle specification to obtain the lifecycle specification;
comparing the lifecycle information to the lifecycle specification; and
determining if the document is compliant with the lifecycle specification.

16. The method of claim 12 further comprising:
scanning the scanning the document, the digital channel and the physical manifestation of the digital representation of the lifecycle specification;
interpreting the digital representation of the lifecycle specification to obtain the lifecycle specification;
comparing the lifecycle specification to an instruction of an operator and
permitting the instruction if the instruction is allowed by the lifecycle specification, or
denying the instruction if the instruction is not allowed by the lifecycle specification.

17. The method of claim 16 further comprising transmitting a message to the operator if the instruction was denied.

18. The method of claim 17 further comprising permitting the instruction if the operator initiates a subsequent instruction allowed by the lifecycle specification in response to the message.

19. The method of claim 12 further comprising:
scanning the scanning the document, the digital channel and the physical manifestation of the digital representation of the lifecycle specification;
interpreting the scanned digital channel to obtain lifecycle information;
interpreting the digital representation of the lifecycle specification to obtain the lifecycle specification;
comparing the lifecycle specification to the lifecycle information; and
initiating an action required by the lifecycle specification if the action is not located in the lifecycle information.

20. A method of authentication and non-repudiation of hard-copy documents, each document having a lifecycle comprising a plurality of states of the document, a set of business rules being applied to each document over the document's lifecycle, the business rules and the lifecycle defining a lifecycle specification, the method comprising
scanning the document with a scanner or a multi-function printer/copier/scanner device at each state of the document;
generating a digital representation of the document's state at each state of the document from the scanned image of the document;
affixing a physical manifestation of each digital representation of the state of the document to the document; and
affixing a physical manifestation of a digital representation of the lifecycle specification to the document.

21. The method of claim 20 further comprising affixing a physical manifestation of a digital signature to the document.

22. An authentication document comprising:
a document and
at least one digital channel associated with the document, the at least one digital channel providing a digital representation of a state of the document.
